(19) United States
(12) Patent Application Publication
(10) Pub. No.: US 2024/0143573 A1
(43) Pub. Date: May 2, 2024

(54) SERVERLESS-BASED BLOCKCHAIN PLATFORM

(71) Applicant: VMware, Inc., Palo Alto, CA (US)

(72) Inventors: Bala Siva Sai Akhil Malepati, Sunnyvale, CA (US); Ramesh Saradhi Tellamsetty, Mountain House, CA (US)

(21) Appl. No.: 17/976,697

(22) Filed: Oct. 28, 2022

(51) Int. Cl. G06F 16/22

(52) U.S. Cl. CPC G06F 16/2291

(57) ABSTRACT

An example method of implementing a blockchain network in a computer system includes: receiving, at an orchestrator executing in the computer system, a blockchain request from an application; querying, by the orchestrator, a platform data store for blockchain configuration data associated with the blockchain network; sending, by the orchestrator, a request having the blockchain configuration data to a container pool manager executing in the computer system; and creating, by the container pool manager, the blockchain network by purposing a first generic container in a generic container pool as a client-purposed container and second generic containers in the generic container pool as replica containers of a replica network.

Blockchain is gaining a lot of momentum in various domains. Blockchain systems are used by Banks, Stock Exchanges, Cryptocurrency, Insurance, etc. This is natural as the concept of blockchain originated from Bitcoin which is a peer-to-peer electronic cash system that falls in the finance domain. These applications for blockchain generally require a high-performance output and throughput from the underlying blockchain platform. Blockchain as an ecosystem is evolving very rapidly and is extending into other domains such as gaming, non-fungible tokens (NFTs), healthcare, advertising, Internet-of-Things (IoT), etc. The needs for the applications from these domains would be very different from the financial domain. As most of the modern-day applications are event driven, these applications demand the blockchain platform handle variable and unpredictable workloads. Blockchain platforms that are available today predominantly use architectures that dedicate resources regardless of the usage, thereby increasing operational costs. In particular, enterprise blockchain platforms today are based on a static blockchain network. A disadvantage to this approach is that it leads to over-provisioning, which in turn leads to unnecessary infrastructure cost and energy consumption.

### SUMMARY

Embodiments include a method of implementing a blockchain network in a computer system. The method includes: receiving, at an orchestrator executing in the computer system, a blockchain request from an application; querying, by the orchestrator, a platform data store for blockchain configuration data associated with the blockchain network; sending, by the orchestrator, a request having the blockchain configuration data to a container pool manager executing in the computer system; and creating, by the container pool manager, the blockchain network by purposing a first generic container in a generic container pool as a client-purposed container and second generic containers in the generic container pool as replica containers of a replica network.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 is a block diagram of a computing system in which embodiments described herein may be implemented.

FIG. 2 is a block diagram depicting a blockchain platform according to embodiments.

FIG. 3 is a flow diagram depicting a method of handling a request at a blockchain platform according to an embodiment.

FIG. 4 is a flow diagram depicting a method of creating a blockchain network in a blockchain platform according to embodiments.

FIG. 5 is a flow diagram depicting a method of reviving a blockchain network in a blockchain platform according to embodiments.

FIG. 6 is a flow diagram depicting a method of vertical scaling of a blockchain network according to embodiments.

FIG. 7 is a flow diagram depicting a method of hibernating a blockchain network according to embodiments.

### DETAILED DESCRIPTION

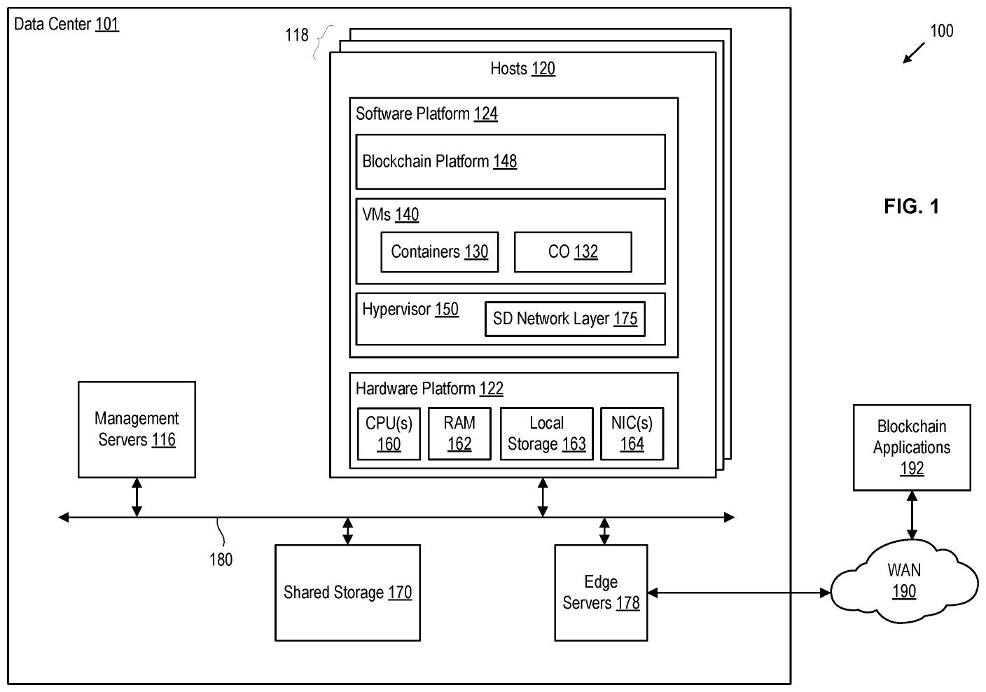

FIG. 1 is a block diagram of a computing system 100 in which embodiments described herein may be implemented. Computing system 100 comprises a data center 101 that includes hosts 120. Hosts 120 may be constructed on hardware platforms such as an x86 architecture platforms. One or more groups of hosts 120 can be managed as clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 180. Physical network 180 enables communication between hosts 120 and between other components and hosts 120 (other components discussed further herein). Data center 101 can be stand alone or can be deployed in a cloud computing system (e.g., a public cloud or a multi-cloud system).

In the embodiment illustrated in FIG. 1, hosts 120 access shared storage 170 by using NICs 164 to connect to network 180. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN, which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. A blockchain platform 148 executes in VMs 140, which is described further below.

In embodiments, computing system 100 is configured with a software-defined (SD) network layer 175. SD network layer 175 includes logical network services executing on virtualized infrastructure of hosts 120. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, computing system 100 includes edge servers 178 that provide an interface of host cluster 118 to wide area network (WAN) 190 (e.g., a corporate network, the public Internet, etc.). Edge servers 178 can include a gateway (e.g., implemented by a router) between the internal logical networking of host cluster 118 and the external network. Edge servers 178 can be physical servers or VMs. Blockchain applications 192 can access blockchain platform 148 through WAN 190 and edge servers 178. Computing system 100 also includes physical network devices (e.g., physical routers/switches) as part of physical network 180, which are not explicitly shown. Management servers 116 include physical or virtual servers that manages hosts 120 and the hypervisors therein, as well as applications deployed on hosts.

In embodiments, software can also execute in containers 130. In embodiments, hypervisor 150 can support containers 130 executing directly thereon. In other embodiments, containers 130 are deployed in VMs 140 or in specialized VMs referred to as “pod VMs.” A pod VM is a VM that includes a kernel and container engine that supports execution of containers, as well as an agent (referred to as a pod VM agent) that cooperates with a controller executing in hypervisor 150. In embodiments, containers 130 are managed by a container orchestrator (CO) 132. CO 132 implements an orchestration control plane, such as Kubemetes®, to deploy and manage applications or services thereof using containers 130. CO 132 can include one or more master servers configured to command and configure containers 130.

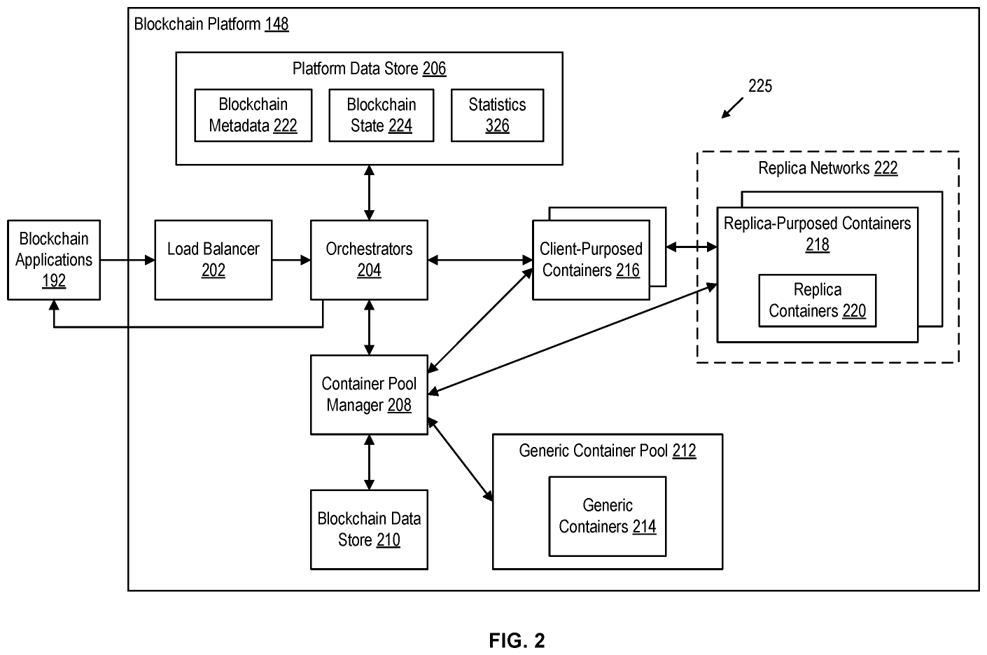

FIG. 2 is a block diagram depicting blockchain platform 148 according to embodiments. Blockchain platform 148 includes a load balancer 202, orchestrators 204, platform data store 206, container pool manager 208, and blockchain data store 210. The components of blockchain platform 148 can execute as software in VMs 140 and all or a portion of the software can execute in containers 130.

Load balancer 202 functions as a gateway for blockchain requests form blockchain applications 192. Load balancer 202 forwards the blockchain requests to a selected one of the orchestrators 204. The orchestrator can be a replicated service comprises a plurality of instances (“orchestrators 204”). Load balancer 202 balances blockchain requests across orchestrators 204.

In embodiments, a blockchain network 225 implemented by blockchain platform 148 includes a client-purposed container 216 and a replica network 222. Blockchain platform 148 can implement a plurality of blockchain networks 225, each of which can be for a different blockchain application 192. Blockchain networks 225 are provisioned as described below.

Orchestrator 204 is configured to route incoming blockchain requests to a corresponding client-purposed container 216 if the corresponding blockchain network 225 is already running in blockchain platform 148. If blockchain network 225 is unavailable, then orchestrator 204 performs operations to create blockchain network 225. This can be an initial creation of a blockchain network 225 or recreating a blockchain network 225 that was previously suspended (referred to as reviving a hibernated blockchain network 225). Orchestrator 204 can perform vertical scale up and vertical scale down operations, as discussed further below. Table 1 depicts operations of orchestrator 204 with respect to initial status, trigger points, end status, and impact.

TABLE 1

| Initial Status | Trigger Point | Operation | End Status | Impact |
|---|---|---|---|---|
| Not Running | Receive | Create | Running at | Provided |
| | blockchain | | required TPS | required |
| | request | | | performance |
| Running at low | Detection of | Vertical scale up | Running at | Provides |
| TPS | higher input | | higher TPS | required |
| | request rate | | | performance |
| Running at high | Detection of | Vertical scale | Running at | Saves cost and |
| TPS | lower input | down | lower TPS | energy |
| | request rate | | | |
| Running at | Detection of no | Hibernate | Not running | Saves cost and |
| arbitrary TPS | input requests | | | energy |
| Hibernated | Receive block | Revive | Running at | Provides |
| | chain requests | | required TPS | required |
| | | | | performance |

As shown in Table 1, if orchestrator 204 receives a blockchain request for a blockchain network 225 that is not running, orchestrator 204 creates the blockchain network (creation process discussed below). This results in blockchain network 225 executing at a require transactions per second (TPS) providing a required performance for the blockchain application. If orchestrator 204 detects a higher input request rate than can be handled by blockchain network 225, orchestrator 204 can perform a vertical scale up operation. This results in blockchain network 225 running at a higher TPS and providing the required performance. If orchestrator 204 detects a lower input request rate such that blockchain network 225 is overprovisioned, orchestrator 204 can perform a vertical scale down operation. This results in blockchain network 225 running at lower TPS and saving cost and energy. If orchestrator 204 detects no input requests for blockchain network 225 after a threshold time period, orchestrator 204 can perform a hibernate operation. This results in blockchain network 225 not running, saving cost and energy. If orchestrator 204 receives block chain requests for a hibernated blockchain network, orchestrator 204 performs a revive operation. This results in blockchain network 225 running at required TPS and providing required performance.

Orchestrator 204 cooperates with platform data store 206 to store and retrieve blockchain configuration data. During initial creation of a blockchain network 225, orchestrator 204 stores blockchain configuration data for the new blockchain network in platform data store 206. In embodiments, blockchain configuration data includes blockchain metadata 222, blockchain state 224, and statistics 326. During initial creation, some portion of blockchain configuration data can be empty (e.g., statistics 326). Blockchain metadata 222 includes data that describes a blockchain network 225. For example, blockchain metadata 222 can include a number of replicas, certificates, resource configurations for the replica network and the client, and the like. Throughout the lifecycle of a blockchain network 225, orchestrator 204 can persist updates to blockchain metadata 222 to platform data store 206. Blockchain state 224 describes the current state of a blockchain network 225. Example states include running, hibernated, not running, current TPS, and the like. Orchestrator 204 can persist updates to blockchain state 225 depending on its operations (e.g., creation, hibernation, revival, vertical scale up, vertical scale down, etc.). Statistics 326 include data generated by operation of a blockchain network 225. For example, how often and how did an application perform blockchain requests (e.g., a number of operations, categorized by type over a period of time). Another statistic is related to resource utilization of replica network 222 and client-purposed container 216 (e.g., CPU, memory, storage, and other resource utilization information). Another statistic measures the overall throughput of a blockchain network 225, i.e., the TPS performance delivered. Those skilled in the art will appreciate that other types of statistics related to a blockchain network 225 can be measured and stored as statistics 326 in platform data store 206.

Whenever an application submits a blockchain request, orchestrator 204 logs the request in platform data store 206 (e.g., by updating statistics 326). A blockchain request is an operation that requires interaction with a blockchain network 225. This operation can be a read operation, a write operation, or an update operation for an object backed by blockchain network 225 from the application's point of view. Orchestrator 204 also periodically checks the resource usage of a blockchain network 225 and updates blockchain metadata 222 and/or blockchain state 224. The blockchain configuration data stored in platform data store 206 for a blockchain network 225 help orchestrator 204 in making decisions regarding vertical scaling and hibernation of the blockchain network.

Blockchain data store 210 is configured to store blockchain network data for an active blockchain network 225. Blockchain data store 210 functions in saving blockchain network data stored by a blockchain network during a hibernation operation. Blockchain data store 210 functions to restore blockchain network data to a blockchain network being created during a revive operation. On request of hibernation by orchestrator 204, container pool manager 208 persists blockchain network data from block chain network 225 (e.g., data stored in replica network 222 and by client-purposed container 216) to blockchain data store 210. The blockchain network data is stored in blockchain data store 210 with isolation from other blockchains implemented by blockchain platform 148. During revival in response to a revive request from orchestrator, container pool manager 208 retrieves the blockchain network data from blockchain data store 210 and loads it to client purposed container 216 and replica network 222.

Container pool manager 208 includes several functions. Container pool manager 208 is configured to maintain a generic container pool 212. Generic container pool 212 includes a pool of generic containers 214. A generic container 214 includes a base level of functionality that enables it to function as a node in a blockchain network (functionality not specific to client or replica nodes, but rather common to both types of nodes). Generic containers 214 can also vary in resource limits, such as CPU, memory, storage, etc. resource limits. Generic container pool 212 having different resource limit-based generic containers assists in creating replica networks 222 and client-purposed containers 216 to satisfy different performance needs for different blockchain networks 225. Container pool manager 208 manages generic container pool 212 to create more generic containers 214 to replenish the pool as the generic containers are consumed in the process or getting purposed as client-purposed containers 2126 and replica containers 220. Container pool manager 208 manages generic container pool 212 to destroy generic containers 214 as generic containers are returned to generic container pool to conserve resources.

Container pool manager 208 also performs operations requested by orchestrator 204. Orchestrator 204 provides requests to container pool manager 208 based on various triggers, such as those depicted in Table 1 above (e.g., create, hibernate, revive, vertical scaling, etc.). Container pool manager 208 creates a blockchain network 225 using blockchain configuration data obtained from orchestrator 204 by repurposing generic containers 214 into client-purposed container 216 and replica containers 220 according to the blockchain configuration data. Container pool manager 208 performs vertical scaling in response to a request by first performing hibernation of a blockchain network 225 and then creating a new blockchain network 225 using generic containers 214 from generic container pool 212. The containers are matched based on different resource limits to achieve the different performance requirement as needed per the vertical scale up or scale down request. Container pool manager 208 performs hibernation in response to a request by storing the blockchain network data in blockchain data store 210 and then purging the blockchain network data from replica network 222 and client-purposed container 216. Hibernation takes blockchain network 225 from a running state to a rest state. As the blockchain is at rest, and secured using isolation in blockchain data store 210, the blockchain is Byzantine Fault Tolerant (BFT) by default. Container pool manager 225 performs revival in response to a request by creating a blockchain network from generic containers 214 and loading the blockchain network data from blockchain data store 210 to client-purposed container 216 and replica network 222.

Container pool manager 208 is configured to purpose generic containers 214 during the various operations described above (e.g., creating a blockchain network 225 initially, during revival, or during vertical scaling). Container pool manager 208 can purpose a generic container 214 to produce a client-purposed container 216 by adding client functionality to the software of the container. Container pool manager 208 can purpose a generic container 215 to produce a replica container 220 by adding replica functionality to the software of the container.

As used herein, a blockchain is a data structure that holds a group of records and is maintained by a blockchain network 225. These groups of records create a block and the blocks are linked using cryptography. Each block contains a cryptographic hash of the previous block. The records are saved as a list of keys and their values, which comprises the state of the blockchain (including in the blockchain network data). A block shows the results of the executed transactions that have been committed to the blockchain ledger. A client (implemented by a client-purposed container 216) sends requests to a replica network and receives results after running those requests. A replica network (implemented by replica network 222) is a network comprising replica nodes that use an authenticated key-value storage and a deterministic state machine to store code and state in the blockchain. The replica nodes use a protocol, such as a BFT protocol, to create consensus and to maintain the same state on all replica nodes, even if some replica nodes are down or malicious. A replica node (implemented by a replica container 220) participates in the state machine replication protocol. Container pool manager 208 adds the functionality in software to a generic container 214 to make the generic container become either a client-purposed container 216 or a replica container 220.

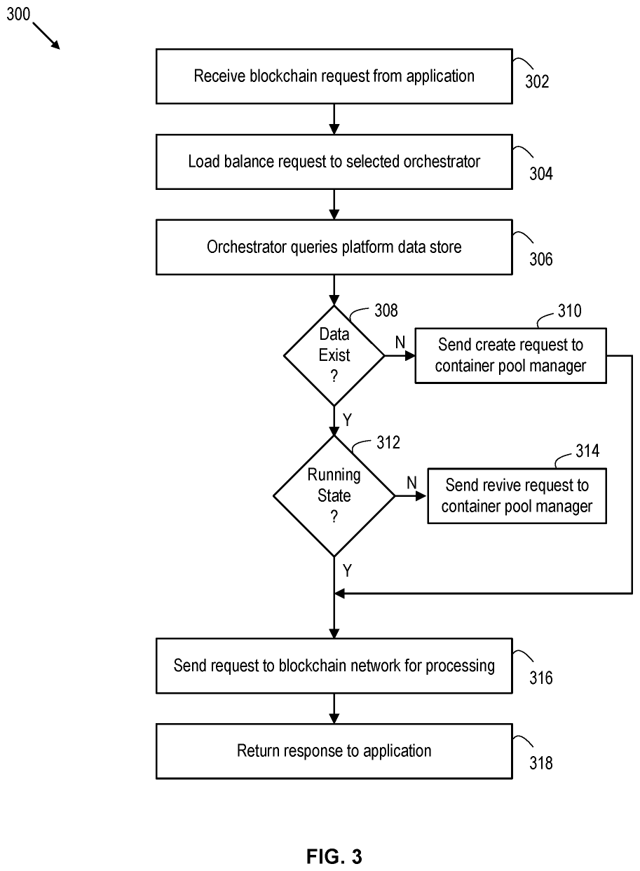

FIG. 3 is a flow diagram depicting a method 300 of handling a request at blockchain platform 148 according to an embodiment. Method 300 begins at step 302, where load balancer 202 receives a request from an application 192. The request can be a read, write, update, or the like request for a blockchain implemented by a blockchain network in blockchain platform 148. At step 304, load balancer 202 sends the request to a selected orchestrator 204 after load balancing. At step 306, orchestrator 204 queries platform data store 206 for blockchain configuration data associated with the blockchain identified in the request. If at step 308 the data exists, the method 300 proceeds to step 312. If at step 308 the data does not exist in platform data store 206, then a blockchain network has yet to be created for the blockchain. In such case, method 300 proceeds from step 308 to step 310, where orchestrator 204 sends a create request to container pool manager 208. Container pool manager 208 creates a blockchain network 225 based on the request (e.g., using a default blockchain configuration or a blockchain configuration identified in the request). A method of blockchain creation is described below.

If at step 312 orchestrator determines blockchain network 225 is in a running state, method 300 proceeds to step 316. Otherwise, blockchain network has been hibernated and needs to be revived. In such case, method 300 proceeds from step 312 to step 314, where orchestrator 204 sends a revive request to container pool manager 208. Container pool manager 208 creates a blockchain network 225 based on the request and the blockchain configuration data retrieved from platform data store 206. A method of blockchain revival is described below.

At step 316, orchestrator 204 sends the request to blockchain network 225 (e.g., to client-purposed container 216 corresponding to blockchain network 225) for processing. At step 318, orchestrator 204 returns a response to the application based on response data from blockchain network 225.

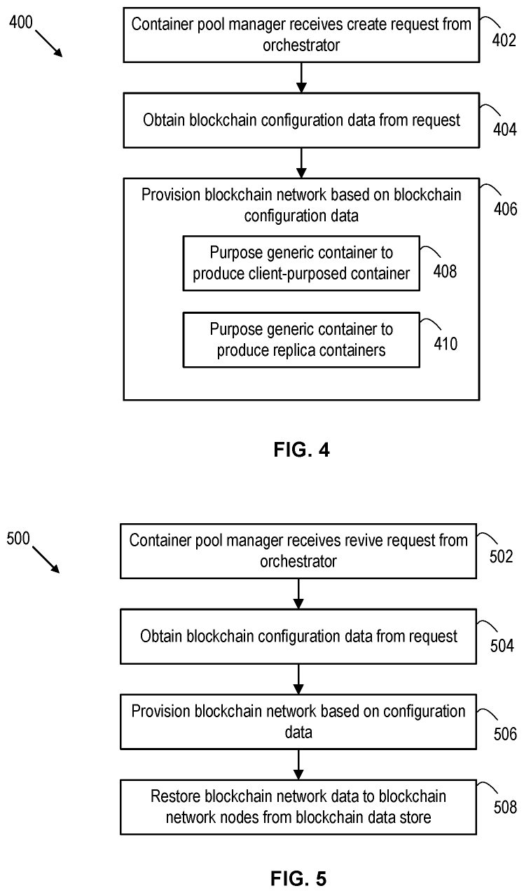

FIG. 4 is a flow diagram depicting a method 400 of creating a blockchain network in blockchain platform 148 according to embodiments. Method 400 begins at step 402, where container pool manager 208 receives a create request from orchestrator 204. At step 404, container pool manager 208 obtains blockchain configuration data from the request. Orchestrator 204 can provide default blockchain configuration data or provide blockchain configuration data based on the request (i.e., as requested by the application). At step 406, container pool manager 208 provisions a blockchain network 225 based on the blockchain configuration data. In particular, at step 408, container pool manager 208 purposes a generic container 214 as a client-purposed container 216. At step 410, container pool manager 208 purposes generic containers 214 as replica containers 220. Container pool manager 208 chooses generic containers having resource limits that match the requirements of the blockchain network being created based on the blockchain configuration data.

FIG. 5 is a flow diagram depicting a method 500 of reviving a blockchain network in blockchain platform 148 according to embodiments. Method 500 begins at step 502, where container pool manager 208 receives a revive request from orchestrator 204. At step 504, container pool manager 208 obtains the blockchain configuration data from the request. Orchestrator 204 retrieves the blockchain configuration data from platform data store 206 and provides it with the request. At step 506, container pool manager 208 provisions a blockchain network 225 based on the configuration data. Provisioning occurs as described above (e.g., steps 408 and 410). At step 508, container pool manager 208 restores blockchain network data to the blockchain network nodes from blockchain data store 210.

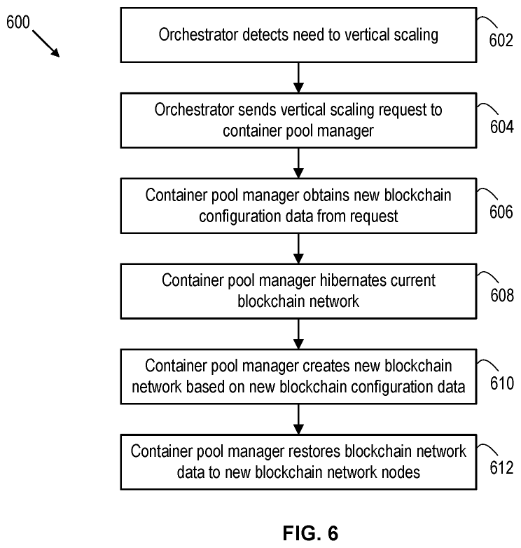

FIG. 6 is a flow diagram depicting a method 600 of vertical scaling of a blockchain network according to embodiments. Method 60) begins at step 602, where orchestrator 204 detects the need for vertical scaling. For example, orchestrator 204 can monitor the TPS for the blockchain network as maintained in statistics 326. Orchestrator 204 can detect the need for vertical scale up in case of a higher TPS and a vertical scale down in case of a lower TPS. At step 604, orchestrator 204 sends a vertical scaling request to container pool manager 208. At step 606, container pool manager 208 obtains new blockchain configuration data from the request (as determined by orchestrator 208). At step 608, container pool manager 208 hibernates the current blockchain network. At step 610, container pool manager 208 creates a new blockchain network based on the new blockchain configuration data. At step 612, container pool manager 208 restores blockchain network data to the nodes of the new blockchain network.

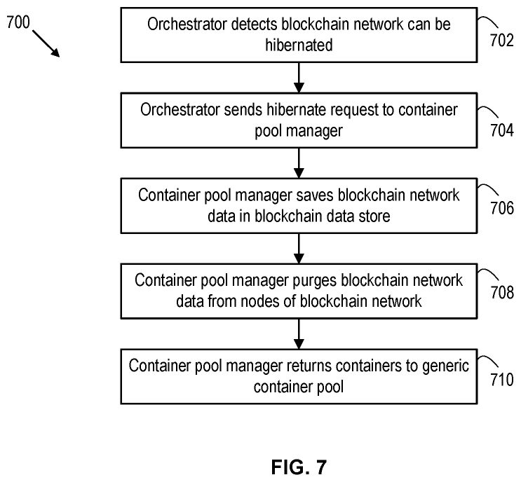

FIG. 7 is a flow diagram depicting a method 700 of hibernating a blockchain network according to embodiments. Method 700 begins at step 702, where orchestrator 204 detects that a blockchain network 225 can be hibernated (e.g., due to no requests after a threshold time period). At step 704, orchestrator 204 sends a hibernate request to container pool manager 208. At step 706, container pool manager 208 saves blockchain network data from the blockchain network in blockchain data store 210. At step 708, container pool manager 208 purges blockchain data from the nodes of the blockchain network being hibernated. Container pool manager 208 can delete the blockchain network data from the client-purposed container and replica containers. At step 710, container pool manager 208 returns the containers to generic container pool 212 as generic containers 214 Container pool manager 208 removes the node-specific functionality from the containers when returning them to generic container pool 212.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of implementing a blockchain network in a computer system, comprising:
receiving, at an orchestrator executing in the computer system, a blockchain request from an application;
querying, by the orchestrator, a platform data store for blockchain configuration data associated with the blockchain network;
sending, by the orchestrator, a request having the blockchain configuration data to a container pool manager executing in the computer system; and
creating, by the container pool manager, the blockchain network by purposing a first generic container in a generic container pool as a client-purposed container and second generic containers in the generic container pool as replica containers of a replica network.

2. The method of claim 1, wherein the step of querying the platform data store returns no data, wherein the orchestrator creates the blockchain configuration data based on the blockchain request, and wherein the request is a create request.

3. The method of claim 2, wherein the container pool manager selects the first generic container and the second generic containers from the generic container pool having resources limits that satisfy the blockchain configuration data.

4. The method of claim 1, wherein the step of querying the platform data store returns information that the blockchain network is hibernated and wherein the request is a revive request.

5. The method of claim 4, wherein the container pool manager selects the first generic container and the second generic containers from the generic container pool having resource limits that satisfy the blockchain configuration data.

6. The method of claim 4, wherein the container pool manager obtains blockchain network data from a blockchain data store and restores the blockchain network data to the blockchain network.

7. The method of claim 1, wherein the orchestrator receives the blockchain request through a load balancer executing in the computer system.

8. A non-transitory computer readable medium comprising instructions to be executed in a computing device to cause the computing device to carry out a method of implementing a blockchain network in a computer system, comprising:
receiving, at an orchestrator executing in the computer system, a blockchain request from an application;
querying, by the orchestrator, a platform data store for blockchain configuration data associated with the blockchain network;
sending, by the orchestrator, a request having the blockchain configuration data to a container pool manager executing in the computer system; and
creating, by the container pool manager, the blockchain network by purposing a first generic container in a generic container pool as a client-purposed container and second generic containers in the generic container pool as replica containers of a replica network.

9. The non-transitory computer readable medium of claim 8, wherein the step of querying the platform data store returns no data, wherein the orchestrator creates the blockchain configuration data based on the blockchain request, and wherein the request is a create request.

10. The non-transitory computer readable medium of claim 9, wherein the container pool manager selects the first generic container and the second generic containers from the generic container pool having resources limits that satisfy the blockchain configuration data.

11. The non-transitory computer readable medium of claim 8, wherein the step of querying the platform data store returns information that the blockchain network is hibernated and wherein the request is a revive request.

12. The non-transitory computer readable medium of claim 11, wherein the container pool manager selects the first generic container and the second generic containers from the generic container pool having resource limits that satisfy the blockchain configuration data.

13. The non-transitory computer readable medium of claim 11, wherein the container pool manager obtains blockchain network data from a blockchain data store and restores the blockchain network data to the blockchain network.

14. The non-transitory computer readable medium of claim 8, wherein the orchestrator receives the blockchain request through a load balancer executing in the computer system.

15. A computing system, comprising:
at least one host having a hardware platform; and
software executing on the hardware platform, the software:
receiving, at an orchestrator of the software, a blockchain request from an application;
querying, by the orchestrator, a platform data store for blockchain configuration data associated with the blockchain network;
sending, by the orchestrator, a request having the blockchain configuration data to a container pool manager of the software; and
creating, by the container pool manager, the blockchain network by purposing a first generic container in a generic container pool as a client-purposed container and second generic containers in the generic container pool as replica containers of a replica network.

16. The computing system of claim 15, wherein the querying the platform data store returns no data, wherein the orchestrator creates the blockchain configuration data based on the blockchain request, and wherein the request is a create request.

17. The computing system of claim 16, wherein the container pool manager selects the first generic container and the second generic containers from the generic container pool having resources limits that satisfy the blockchain configuration data.

18. The computing system of claim 15, wherein the querying the platform data store returns information that the blockchain network is hibernated and wherein the request is a revive request.

19. The computing system of claim 18, wherein the container pool manager selects the first generic container and the second generic containers from the generic container pool having resource limits that satisfy the blockchain configuration data.

20. The computing system of claim 18, wherein the container pool manager obtains blockchain network data from a blockchain data store and restores the blockchain network data to the blockchain network.
